(19) United States
(12) Patent Application Publication
(10) Pub. No.: US 2023/0125044 A1
(43) Pub. Date: Apr. 20, 2023

(54) HEARTBEAT SIMULATION DEVICE

(71) Applicant: NA LU, Shenzhen (CN)

(72) Inventor: NA LU, Shenzhen (CN)

(21) Appl. No.: 17/505,649

(22) Filed: Oct. 20, 2021

(51) Int. Cl. G09B 23/32

(52) U.S. Cl. CPC G09B 23/32

(57) ABSTRACT

The present disclosure provides a heartbeat simulation device, including a housing, an eccentric wheel motor disposed in the housing, and a spring sleeved on the eccentric wheel motor. The spring follows the eccentric wheel motor to vibrate. When the eccentric wheel motor vibrates, the spring sleeved on the eccentric wheel motor is driven to vibrate, the eccentric wheel motor matches with the spring to emit more clean and real sound, which truly simulates a sound of human heartbeats.

### TECHNICAL FIELD

The present disclosure relates to a technical field of electronics, and in particular to a heartbeat simulation device.

### BACKGROUND

Heartbeats are a basic physiological characteristic of human beings, and studies show that people have special reactions to external heartbeats, such as feelings, more secure. As a result, research and development began on products that could generate heartbeats. With development of electronic technology, there are many products that use the electronic technology to simulate generation of heartbeats.

However, the way in which a product in a related art generates the heartbeats is mainly accomplished by a speaker that emits sound like the heartbeats, which is then transmitted to ears of people. The way is greatly affected by external noise and is not ideal in effect.

### SUMMARY

The present disclosure provides a heartbeat simulation device, which provides a heartbeat simulation sense having more ideal effect.

The present disclosure provides the heartbeat simulation device, including a housing, an eccentric wheel motor disposed in the housing, and a spring sleeved on the eccentric wheel motor. The spring follows the eccentric wheel motor to vibrate.

In some embodiments, the eccentric wheel motor includes a rotating part and a main body part.

The spring is sleeved on the main body part. The spring includes a first end distal from the rotating part, and the first end is fixedly connected with the housing.

In some embodiments, the housing includes a fixing part spaced from the eccentric wheel motor, the first end protrudes from the eccentric wheel motor and is fixedly connected with the fixing part.

In some embodiments, a first mounting hole is disposed on the fixing part, and a second mounting hole is disposed on the first end.

The heartbeat simulation device further includes a connecting piece, the connecting piece penetrates through the first mounting hole and the second mounting hole, and the connecting piece fixedly connects the first end with the fixing part.

In some embodiments, the first end is disposed between the connecting piece and the fixing part, and the connecting piece is screwed and fixed with the first mounting hole.

In some embodiments, the spring further includes a spring main body and a connecting rod, the spring main body is sleeved on the main body part, and the spring main body is connected with the first end through the connecting rod.

The housing further includes a supporting part, the supporting part includes a groove, and the connecting rod is disposed in the groove.

In some embodiments, the first end is bent and connected with the spring main body through the connecting rod.

In some embodiments, the spring is fixedly connected with the main body part.

In some embodiments, the heartbeat simulation device further includes a processor. The processor is connected with the eccentric wheel motor and configured to control the eccentric wheel motor to stop working when an operation instruction is not detected within a preset time period.

In some embodiments, the heartbeat simulation device further includes a detector. The detector is connected with the processor. The detector is configured to detect whether a user touches the heartbeat simulation device, and the processor is configured to control the eccentric wheel motor to work when the detector detects that the user touches the heartbeat simulation device.

In the heartbeat simulation device of the present disclosure, the eccentric wheel motor vibrates, so that the spring sleeved on the eccentric wheel motor is driven to vibrate, the eccentric wheel motor matches with the spring to emit more clean and real sound, which truly simulates a sound of human heartbeats. Since the heartbeat simulation device of the present disclosure sends out the sound similar to the human heartbeats through vibration of the eccentric wheel motor and the spring, which does not be easily disturbed by external noise like a loudspeaker, and can also generate an action similar to the human heartbeats, so that there is not only the sound of the heartbeats similar to that of a real heart, but also the heartbeat action similar to the real heart, which is more realistic.

### BRIEF DESCRIPTION OF DRAWINGS

In order to more clearly illustrate technical solutions in embodiments of the present disclosure, the following is a brief description of accompanying drawings that need to be used in the description of the embodiments. Obviously, the drawings in the following description are only some embodiments of the present disclosure, and other drawings may be obtained by those skilled in the art without creative work:

FIG. 1 is a structural schematic diagram of a heartbeat simulation device according to one embodiment of the present disclosure.

FIG. 2 is a structural schematic diagram of the heartbeat simulation device of FIG. 1 shown in another angle.

FIG. 3 is a structural schematic diagram of a partial housing removed in the heartbeat simulation device shown in FIG. 1.

FIG. 4 is a structural schematic diagram of an eccentric wheel motor and a spring of the heartbeat simulation device shown in FIG. 1.

FIG. 5 is a structural schematic diagram of the eccentric wheel motor and the spring before installation shown in FIG. 4.

### DETAILED DESCRIPTION

Technical solutions in embodiments of the present disclosure are clearly and completely described below in conjunction with accompanying drawings in the embodiments of the present disclosure. Obviously, the described embodiments are only a part of the embodiments of the present disclosure, and not all of them. Based on the embodiments in the present disclosure, all other embodiments obtained by those skilled in the art without creative labor fall within scopes of protection of the present disclosure.

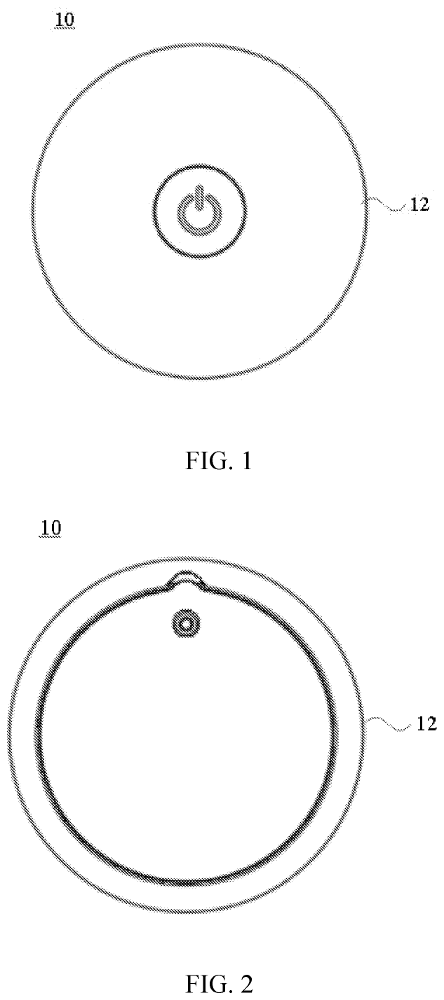

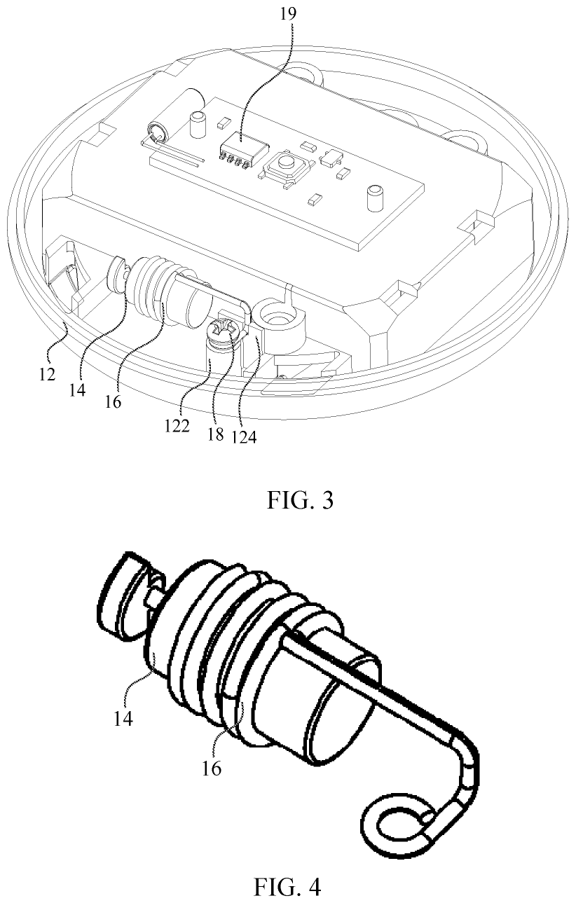

The present disclosure provides a heartbeat simulation device, specifically refer to FIGS. 1-2, FIG. 1 is a structural schematic diagram of a heartbeat simulation device according to one embodiment of the present disclosure, FIG. 2 is a structural schematic diagram of the heartbeat simulation device of FIG. 1 shown in another angle, and FIG. 3 is a structural schematic diagram of a partial housing removed in the heartbeat simulation device shown in FIG. 1.

The heartbeat simulation device 10 includes a housing 12, an eccentric wheel motor 14, and a spring 16. The housing 12 may include an accommodation cavity, and the housing 12 may serve as a carrier member of the heartbeat simulation device 10. The eccentric wheel motor14 is disposed in the housing 12, it may be understood that the eccentric wheel motor 14 is disposed in the accommodation cavity of the housing 12. The housing 12 serves to protect the eccentric wheel motor 14. The spring 16 is sleeved on the eccentric wheel motor 14 and follows the eccentric wheel motor 14 to vibrate.

When the eccentric wheel motor 14 vibrates, the spring 16 sleeved on the eccentric wheel motor 14 is driven to vibrate, the eccentric wheel motor 14 matches with the spring 16 to emit more clean and real sound, which truly simulates a sound of human heartbeats. In the embodiment, the heartbeat simulation device 10 of the present disclosure sends out the sound similar to the human heartbeats through vibration of the eccentric wheel motor 14 and the spring 16, which does not be easily disturbed by external noise like a loudspeaker, and can also generate an action similar to the human heartbeats, so that there is not only the sound of the heartbeats similar to that of a real heart, but also the heartbeat action similar to the real heart, which is more realistic.

In particular, when the heartbeat simulation device 10 directly contacts with users, the users may not only hear a beating sound similar to the human heartbeats, but also feel vibration of the eccentric wheel motor 14 and the spring 16, which effect is more realistic, so that people or animals may leave from loneliness and anxiety, as if there is always someone with them.

Signals for driving the eccentric wheel motor 14 may be set according to requirements, such as pulse signal, square wave signal, or sine wave signal, etc. The embodiments of the present disclosure do not limit the signals for driving the eccentric wheel motor 14, and any signal that can drive the eccentric wheel motor 14 to work is within the scopes of the protection of the present disclosure.

Types of the eccentric wheel motor 14 may also be set according to requirements. For example, the eccentric wheel motor 14 may be a hollow cup motor having a diameter of Φ6*10 mm, a size of a rotor of the eccentric wheel motor 14 may be 5*1.5 mm, a vibration frequency range of the eccentric wheel motor 14 may be 10-55-10 HZ, amplitude 14 may be 1.5 mm, and acceleration may be 22 m/s². It should be noted that the above parameter values of the eccentric wheel motor 14 are merely exemplary examples, and in some other embodiments, any one of the parameter values of the eccentric wheel motor 14 in the embodiment can be adjusted as needed, and the parameter values of the eccentric wheel motor 14 are not limited here.

The spring 16 in the embodiment may also be set according to requirements. For example, materials of the spring 16 may be a metal or metal alloy, such as carbon steel or other spring steel. A wire diameter of the spring 16 may be 0.8 mm and a length of which may be 20 mm. It should be noted that the above parameter values of the spring 16 are merely exemplary examples, and in other embodiments, any one of the parameter values of the spring 16 in the embodiment can be adjusted as needed, and the parameter values of the spring 16 are not limited here.

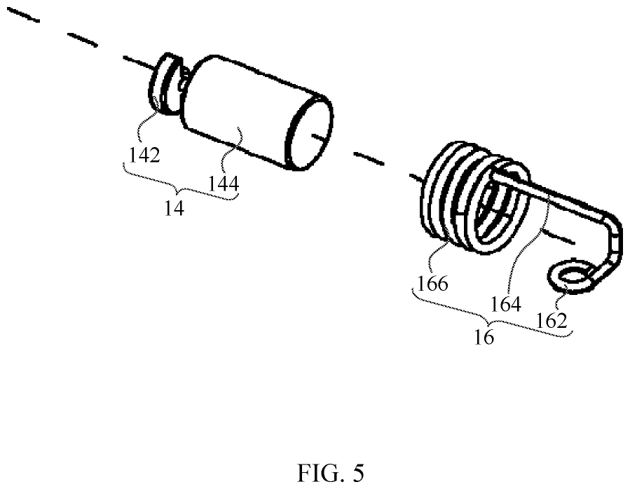

Please further refer to FIGS. 4-5, FIG. 4 is a structural schematic diagram of the eccentric wheel motor and the spring of the heartbeat simulation device shown in FIG. 1, and FIG. 5 is a structural schematic diagram of the eccentric wheel motor and the spring before installation shown in FIG. 4. The eccentric wheel motor 14 includes a rotating part 142 and a main body part 144. The spring 16 is sleeved on the main body part 144. The spring 16 includes a first end 162 distal from the rotating part 142, and the first end 162 is fixedly connected with the housing 12.

The rotating part 142 of the eccentric wheel motor 14 may be eccentrically rotated so as to drive the main body part 144 connected thereto to vibrate. The spring 16 is sleeved on the main body part 144 so as to follow vibration of the main body part 144 to vibrate. The first end 162, distal from the rotating part 142, of the spring 16 may be fixedly connected with the housing 12 to limit the eccentric wheel motor 14 and the spring 16 without losing control of the eccentric wheel motor 14 and the spring 16.

The housing 12 includes a fixing part 122 spaced from the eccentric wheel motor 14, the first end 162 protrudes from the eccentric wheel motor 14 and is fixedly connected with the fixing part 122. The first end 162 needs to protrude from the eccentric wheel motor 14 and is fixedly connected with the fixing part 122 of the housing 12 so as to not affect the rotation and vibration of the eccentric wheel motor 14.

A first mounting hole is disposed on the fixing part 122, and a second mounting hole is disposed on the first end 162. The heartbeat simulation device 10 further includes a connecting piece 18, the connecting piece 18 penetrates through the first mounting hole and the second mounting hole, and the connecting piece 18 fixedly connects the first end 162 with the fixing part 122.

The fixing part 122 and the first end 162 are fixedly connected through the connecting piece 18, so that requirements for the fixing part 122 and the first end 162 are low and no special treatment is required for the fixing part 122 and the first end 162, and there is only a need that the first mounting hole and the second mounting hole are respectively disposed on the fixing part 122 and the first end 162. For example, the first end 162 is disposed between the connecting piece 18 and the fixing par 122, and the connecting piece 18 is screwed and fixed with the first mounting hole. Specifically, the spring 16 and the fixing part 122 are fixedly connected through the connecting piece 18, the first mounting hole includes threads, the connecting piece 18 may be a screw, so that screwing and fixing the connecting piece 18 with the first mounting hole is achieved. Thus, the connecting piece 18 and the first mounting hole is detachably connected, which is convenient to be disassembled and assembled, thereby facilitating installation, disassembly, and maintenance.

In other embodiments, the first end 162 and the fixing part 122 may also be fixedly connected through other means. For example, the first end 162 and the fixing part 122 may be fixedly connected through welding, adhesive fixing connection, or clamping and fixing connection.

The spring 16 further includes a spring main body 166 and a connecting rod 164, the spring main body 166 is sleeved on the main body part 144, and the spring main body 166 is connected with the first end 162 through the connecting rod 164. The housing 12 further includes a supporting part 124, the supporting part 124 includes a groove, and the connecting rod 164 is disposed in the groove.

The spring 16 often vibrates, and the first end 162 of the spring 16 also vibrates, thereby affecting a fixing connection effect between the first end 162 and the fixing part 122. Thus, a supporting part 124 may be further provided to the connecting rod 164 between the first end 162 and the spring main body 166, the supporting part 124 may support the connecting rod 164, when the spring 16 vibrates, the supporting part 124 may bear vibration transmitted by the connecting rod 164, so that the fixing connection effect between the first end 162 and the fixing part 122 is maintained. In addition, the connecting rod 164 may be disposed in the groove of the supporting part 124, the groove may limit the connecting rod 164, such as limiting two sides and a bottom of the connecting rod 164, so as to limit the spring 16 and the eccentric wheel motor 14.

The first end 162 is bent and connected with the spring main body 166 through the connecting rod 164. For example, the spring main body 166 is disposed along a first direction, the first end 162 is disposed along a second direction, the first direction and the second direction are at a preset angle, such as between 60 degrees and 120 degrees, the first direction may also be perpendicular to the second direction, so that a length of the spring 16 along the first direction become shorter, and the spring 16 is better placed in the accommodation cavity of the housing 12, which saves space.

The housing 12 includes a bottom housing, the fixing part 122 protrudes from the bottom housing, and the spring 16 is spaced from the bottom housing, that is, the spring 16 is suspended on the bottom housing. Certainly, in other embodiments, the spring 16 is may be also disposed on the bottom housing.

The spring 16 is fixedly connected with the main body part 144. For example, the spring 16 and the main body part 144 may be fixedly connected through the adhesive fixing connection, the spring 16 and the main body part 144 may be fixedly connected through interference fit, and the spring 16 and the main body part 144 may also be fixed connected through welding, etc.

The heartbeat simulation device 10 further includes a processor 19. The processor 19 is connected with the eccentric wheel motor 14 and configured to control the eccentric wheel motor 14 to stop working when an operation instruction is not detected within a preset time period.

When the heartbeat simulation device 10 works for the preset time period, the heartbeat simulation device automatically stops, so that energy can be effectively saved.

The preset time period may be set according to requirements. For example, the preset time period may be 6 hours, 8 hours, 10 hours, etc. The preset time period may also be adjusted according to an instruction of the users, such as an adjustment button is disposed on the heartbeat simulation device 10, and the users may adjust the preset time period through adjusting the adjustment button. The heartbeat simulation device 10 may also include a communication module, the users may communicate with the communication module of the heartbeat simulation device 10 through other devices, and send a new value to the processor 19 through the communication module. The processor 19 adjusts a value of the preset time period according to the received new value, such as from 8 hours to 12 hours.

The operation instruction may be an instruction received through a button of the heartbeat simulation device 10, may be an instruction detected through a sensor of the heartbeat simulation device 10, and may also be an instruction sending from other devices and received through the communication module. For example, the heartbeat simulation device 10 includes a trigger button, if the trigger button receives a press operation, the operation instruction is considered to be received. For another example, the heartbeat simulation device 10 includes a sensor (such as a gravity sensor, an acceleration sensor, and a vibration sensor), if the sensor detects that the heartbeat simulation device 10 is touched by the users, the operation instruction is considered to be received. For another example, if the communication module receives a work signal sent by other devices (such as a cell phone and a remote controller) of the users, the operation instruction is considered to be received.

The heart simulation device 10 has a function of vibration induction awakening. Illustratively, the heartbeat simulation device 10 further includes a detector connected with the processor 19 and configured to detect whether a user touches the heartbeat simulation device 10, and the processor 19 is configured to control the eccentric wheel motor 14 to work when the detector detects that the user touches the heartbeat simulation device 10.

When the heartbeat simulation device 10 does not work, a switch button is not required to be pressed down, so long as the heartbeat simulation device 10 is slightly touched, a heartbeat module may automatically sense and continue to work, the heartbeat simulation device 10 may immediately enter a working state as the user needed, there is no tedious operation, which is convenient and fast.

In other embodiments, the heartbeat simulation device 10 may automatically stop after the preset time period. At this time, there is no need to press the switch button to turn on the heartbeat simulation device 10 again, so long as the heartbeat simulation device 10 is slightly touched, the heartbeat module may automatically sense and continue to work for a preset time period, which not only plays a role in saving energy, but also immediately enters the working state as the user needed, there is no tedious operation, which is convenient and fast.

The heartbeat simulation device 10 may further include the switch button, an opening is formed on the housing 12 with respect to the switch button, the switch button is convenient for the users to operate, and the switch button may be configured to open and close electrical components, such as the eccentric wheel motor 14. Certainly, the electrical components, such as the eccentric wheel motor 14, may also automatically opens through the vibration sensor.

A shape of the housing 12 may be circular, and a size of the housing 12 may be Φ73*28 mm. The electrical components, such as the eccentric wheel motor 14, of the heartbeat simulation device 10, may be powered using a battery, the battery may be a rechargeable battery or a non-rechargeable battery. For example, the battery may be a multi-node AA or AAA battery. For another example, the battery may be a rechargeable lithium battery. A charging interface is further disposed on the housing 12, a corresponding charging circuit is further disposed in the heartbeat simulation device 10, one end of the charging circuit is connected to the charging interface, and another end of the charging circuit is connected to the rechargeable lithium battery. It should be noted that the shape of the housing 12 may also be other shapes, such as square, spherical, oval or cylindrical, etc.

The heartbeat simulation device 10 may also include a mesh fabric, which may be one or more of wool, rabbit hair, cashmere, silk, polyvinyl acetal fibers, cotton fibers, cotton cloth, acrylic fibers, etc. The mesh fabric may form a blanket, a quilt, a plush toy, etc. The housing 12 may be mounted in the mesh fabric, such as within a felt or plush toy.

The heartbeat simulation device 10 in the present disclosure controls the rotation of the eccentric wheel motor 14 through a specific pulse signal and is cooperated with the vibration of the spring 16, so that the heartbeat simulation device 10 emits beating sound and vibration, thereby achieving a situation of simulating the beating of the human hearts. The heartbeat simulation device 10 helps people or animals to relieve restlessness and loneliness mood, and play a role of accompanying and pacifying. It may also be used in conjunction with a blanket mat or a plush metric for good sleep aiding in people or animals. The blanket mat or the plush male may act as a toy for pets and people.

The above provides a detailed description of the heartbeat simulation device provided by embodiments of the present disclosure. In this paper, specific examples are applied to illustrate the principle and implementation of the present disclosure, and the above description of embodiments is only used to help understand the present disclosure. At the same time, for those who skilled in this art, according to the idea of the present disclosure, there will be changes in the specific implementation and application scopes, in summary, the content of this specification should not be understood as a limitation of the present disclosure.

What is claimed is:

1. A heartbeat simulation device, comprising:
a housing;
an eccentric wheel motor disposed in the housing; and
a spring sleeved on the eccentric wheel motor;
wherein the spring follows the eccentric wheel motor to vibrate.

2. The heartbeat simulation device according to claim 1, wherein the eccentric wheel motor comprises a rotating part and a main body part; the spring is sleeved on the main body part; the spring comprises a first end distal from the rotating part, and the first end is fixedly connected with the housing.

3. The heartbeat simulation device according to claim 2, wherein the housing comprises a fixing part spaced from the eccentric wheel motor, the first end protrudes from the eccentric wheel motor and is fixedly connected with the fixing part.

4. The heartbeat simulation device according to claim 3, wherein a first mounting hole is disposed on the fixing part, and a second mounting hole is disposed on the first end; the heartbeat simulation device further comprises a connecting piece, the connecting piece penetrates through the first mounting hole and the second mounting hole, and the connecting piece fixedly connects the first end with the fixing part.

5. The heartbeat simulation device according to claim 4, wherein the first end is disposed between the connecting piece and the fixing part, and the connecting piece is screwed and fixed with the first mounting hole.

6. The heartbeat simulation device according to claim 2, wherein the spring further comprises a spring main body and a connecting rod, the spring main body is sleeved on the main body part, and the spring main body is connected with the first end through the connecting rod; the housing further comprises a supporting part, the supporting part comprises a groove, and the connecting rod is disposed in the groove.

7. The heartbeat simulation device according to claim 2, wherein the first end is bent and connected with the spring main body through the connecting rod.

8. The heartbeat simulation device according to claim 5, wherein the spring is fixedly connected with the main body part.

9. The heartbeat simulation device according to claim 1, further comprising a processor; wherein the processor is connected with the eccentric wheel motor and configured to control the eccentric wheel motor to stop working when an operation instruction is not detected within a preset time period.

10. The heartbeat simulation device according to claim 9, further comprising a detector; wherein the detector is connected with the processor; the detector is configured to detect whether a user touches the heartbeat simulation device, and the processor is configured to control the eccentric wheel motor to work when the detector detects that the user touches the heartbeat simulation device.
